(19) United States
(12) Patent Application Publication
(10) Pub. No.: US 2008/0261008 A1
(43) Pub. Date: Oct. 23, 2008

(54) Anti-reflection film

(75) Inventors: Kazutoshi Kiyokawa, Kawaguchi-shi (JP); Yuki Watanabe, Kasukabe-shi (JP); Takayuki Tani, Kasukabe-shi (JP); Yasunori Kurauchi, Kuki-shi (JP)

Correspondence Address: STAAS & HALSEY LLP, SUITE 700, 1201 NEW YORK AVENUE, N.W., WASHINGTON, DC, 20005, US

(73) Assignee: TOPPAN PRINTING CO., LTD., Tokyo (JP)

(21) Appl. No.: 12/081,500

(22) Filed: Apr. 16, 2008

(30) Foreign Application Priority Data
Apr. 18, 2007 (JP) P2007-109169

(51) Int. Cl. B32B 7/02

(52) U.S. Cl. 428/216

(57) ABSTRACT

An anti-reflection film, including: a transparent base film; and an anti-reflection stacked member provided on the hard coating, having, in alternation, a high-refractivity oxide thin film layer and a low-refractivity oxide thin film layer, wherein: an outermost layer of the anti-reflection stacked member is the low-refractivity oxide thin film layer; the low-refractivity oxide thin film layer is a silicon oxide thin film; a thickness of the silicon oxide thin film is in a range of 75 nm or greater, and 100 nm or smaller; the silicon oxide thin film has a first layer on a side of the transparent base film, and a second layer on an outside of the first layer; and a composition ratio Si/O (A) of silicon to oxygen in the first layer and a composition ratio Si/O (B) of silicon to oxygen in the second layer satisfies a relationship, Si/O (A)>Si/O (B).

### BACKGROUND OF THE INVENTION

Priority is claimed on Japanese Patent Application No. 2007-109169, filed Apr. 18, 2007, the content of which is incorporated herein by reference.

### FIELD OF THE INVENTION

The present invention relates to an anti-reflection film.

### DESCRIPTION OF RELATED ART

In LCDs (Liquid Crystal Displays), CRTs (Cathode Ray Tubes), PDPs (Plasma Display Panels), EL (Electro Luminescence) devices, touch panels, and other optical display devices, anti-reflection films which prevents the inclusion of reflected external light, such as sunlight and light from a fluorescent lamp, is often used. Recently, in addition to use indoors, there has also been increasing use in outdoor applications, with the widespread use of digital cameras, cellular telephones, digital camcorders, and other portable equipments, as well as car navigation systems.

For outdoor use, since the reflection of external light is greater, AR (anti-reflection) film to prevent reflection is sought which has a reflectivity as close to zero as possible. In general, dry coating techniques, enabling formation of thin multilayer film controlled at the level of several nanometers, are used to form AR film. Of these, sputtering methods can be used to form thin films having exceedingly higher mechanical film strength, e.g. abrasion resistance, as compared with thin films made with other methods, such as evaporation deposition, ion plating, CVD, and other dry coating methods. Such techniques are disclosed for example in Japanese Unexamined Patent Application, First Publication No. 2000-52492 and Japanese Unexamined Patent Application, First Publication No. 2001-96669.

On the other hand, due to the mode of actual use and demands imposed by manufacturing processes, flexibility is often required of anti-reflection films, and the establishment of both mechanical strength and flexibility has been a challenge. In the past, there have been a number of related inventions, but further improvements have still been sought.

Specifically, silicon oxide thin film formed by a sputtering method has high mechanical strength, and is optimal for use as an outermost-layer thin film of an anti-reflection stacked layer member. However, there is the drawback that if the mechanical strength is increased, flexibility becomes inadequate, while if the flexibility is increased, the mechanical strength becomes inadequate. Hence it is necessary to find a method to attain both flexibility and mechanical strength. The present invention was devised in light of these circumstances, and has as an object to establish both mechanical strength and flexibility at the same time in anti-reflection films.

### SUMMARY OF THE INVENTION

The present invention employed the followings in order to achieve the above object.

(1) That is, the present invention employs an anti-reflection film, including: a transparent base film, on at least one face of which is provided a hard coating; and an anti-reflection stacked member provided on the hard coating, having, in alternation, a high-refractivity oxide thin film layer and a low-refractivity oxide thin film layer, wherein: an outermost layer of the anti-reflection stacked member is the low-refractivity oxide thin film layer; the low-refractivity oxide thin film layer is a silicon oxide thin film; a thickness of the silicon oxide thin film is in a range of 75 nm or greater, and 100 nm or smaller; the silicon oxide thin film has a first layer on a side of the transparent base film, and a second layer on an outside of the first layer; and a composition ratio Si/O (A) of silicon to oxygen in the first layer and a composition ratio Si/O (B) of silicon to oxygen in the second layer satisfies a relationship, Si/O (A)>Si/O (B).

According to the anti-reflection film described above, an anti-reflection film is obtained which has both superior mechanical properties, e.g. abrasion resistance, and flexibility, without detracting from the optical characteristics required of the anti-reflection film.

(2) In the anti-reflection film described above, the composition ratio Si/O (A) of silicon to oxygen in the first layer and the composition ratio Si/O (B) of silicon to oxygen in the second layer may satisfy a relationship, 0.60≧Si/O (A)≧Si/O (B).
(3) Furthermore, in the anti-reflection film described above, a ratio t (A)/t (B) of a thickness t (A) of the first layer to a thickness t (B) of the second layer may satisfy a relationship, 4.5≧t (A)/t (B)≧0.8.
(4) Furthermore, in the anti-reflection film described above, the high-refractivity oxide thin film layer may include niobium oxide.
(5) Furthermore, in the anti-reflection film described above, the transparent base film may include triacetyl cellulose.

### BRIEF DESCRIPTION OF THE DRAWINGS

FIG. 1 shows the configuration of one example of an anti-reflection film of the present invention.

### DETAILED DESCRIPTION OF THE INVENTION

The present invention is explained below in detail.

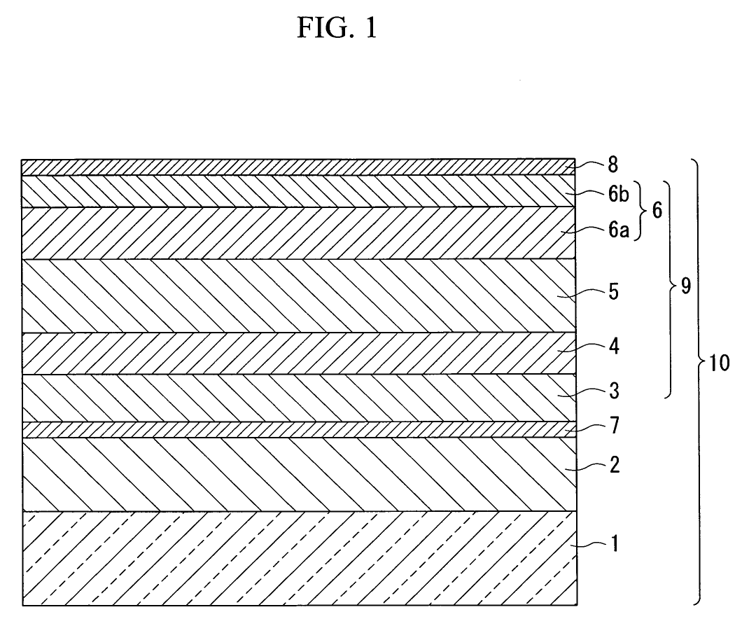

FIG. 1 shows an example of the cross-sectional structure of an anti-reflection film of the invention. The anti-reflection film 10 of the present invention includes a hard coating layer 2 deposited on at least one face of the triacetyl cellulose film used as the transparent base film 1.

As the transparent base film 1, any film which is transparent can be used. However, among anti-reflection films for use in optical display devices, triacetyl cellulose (TAC), polyethylene terephthalate (PET), polyethylene naphthalate (PEN), acrylics, and other films are used for their superior optical characteristics, mechanical strength, and other properties. In particular, TAC film is preferable for use in rapidly expanding LCD applications. Flexibility is particularly emphasized in anti-reflection films, and TAC film is extremely useful in the present invention due to the characteristics of possible extensions in dimension of such films. The thickness of the transparent base film 1 may be selected appropriately according to the application; normally a thickness of approximately 25 to 300 μm is preferable from the standpoints of mechanical strength, handling properties, and optical device design. In the case of TAC film, 40 μm and 80 μm thick films are widely used. Also, the transparent base film 1 may include a plasticizer, an ultraviolet absorber, a degradation inhibitor, or other additives, as necessary.

As the hard coating layer 2 formed on the transparent base film 1, a resin which is cured using ionizing radiation or ultraviolet rays, or a thermosetting resin, is used. Ultraviolet curing resins such as acrylate esters, acrylamides, methacrylate esters, methacrylic amides, other acrylic resins, organic silicon resins, and polysiloxane resins are suitable. In order to improve curing properties, a polymerization initiator may be added to these materials. The physical film thickness of the hard coating layer 2 is 0.5 μm or greater, and preferably 3 to 20 μm. Furthermore, transparent particles of average diameter from 0.01 to 3 μm may be dispersed in the hard coating layer 2, to perform anti-glare treatment (treatment to reduce apparent reflected light through scattering).

Prior to forming the anti-reflection stacked member on the hard coating layer 2, surface treatment of the surface of the hard coating layer 2 may be performed, in order to improve the adhesion strength. At this time, as the surface treatment method, corona discharge treatment, glow discharge treatment, ion beam treatment, atmospheric pressure plasma treatment, saponification treatment, or the like may be performed.

When it is necessary to further enhance the adhesion strength, after the surface treatment and before the formation of the anti-reflection stacked member, a primer layer 7 may be provided. As the material for the primer layer 7, for example, silicon, nickel, chromium, tin, gold, silver, platinum, zinc, titanium, tungsten, zirconium, palladium, or other metals, or alloys of two or more of these metals, or oxides, fluorides, sulfides, nitrides, or the like, of these may be used. In particular, a primary layer of Si, SiOₓ, or the like including silicon is superior as a primer layer for an anti-reflection stacked member employing an oxide thin film. It is preferable that these primer layers be formed using a sputtering method, reactive sputtering method, evaporation deposition method, ion plating method, chemical vapor deposition (CVD) method, or other dry coating methods. Moreover, the thickness of the primer layer may be decided according to the objectives, but a thickness in the range of approximately 1 to 20 nm is normally used.

The anti-reflection stacked member 9 can generally be formed by a sputtering method, evaporation deposition method, chemical vapor deposition (CVD) method, or other dry coating methods. Of these, sputtering method enables formation of a fine-textured film, and a thin film is obtained having superior mechanical strength, e.g. abrasion resistance. Among sputtering methods, a reactive sputtering method, in which the low deposition rate of the conventional sputtering methods is greatly improved, is appropriate. Reactive sputtering is a method in which, when, for example, depositing a silicon oxide thin film, a silicon target is used, oxygen gas is introduced as a reactive gas, and a silicon oxide thin film is deposited.

The anti-reflection stacked member 9 has a stacked member including high-refractivity oxide thin film layers and low-refractivity oxide thin film layers stacked in alternation, and the outermost thin film layer of which is a low-refractivity oxide thin film layer. In particular, when a four-layer configuration is used, a superior balance between cost and performance is achieved, and so it is preferable that a four-layer stacked member, in which high-refractivity oxide thin film layers and low-refractivity oxide thin film layers are stacked in alternation, be used.

As the material of the high-refractivity oxide thin film layers 3 and 5, niobium oxide, titanium oxide, indium oxide, tin oxide, zinc oxide, zirconium oxide, tantalum oxide, hafnium oxide and the like, or mixtures of these, can be used. In particular, niobium oxide and titanium oxide are normally widely employed in anti-reflection film applications. Among these, niobium oxide is suitable for sputtering due to the small number of pinholes in the resulting thin film.

As the material of the low-refractivity oxide thin film layers 4 and 6, silicon oxide, magnesium fluoride, and the like can be used. In particular, silicon oxide is most suitable for anti-reflection film applications from the standpoints of optical characteristics, mechanical strength, suitability for film deposition, cost, and other factors.

Considering the anti-reflection film performance, cost, mechanical strength, and productivity of actual products, a thickness range of 75 nm or greater and 100 nm or less is preferable for the silicon oxide thin film which is the outermost low-refractivity oxide thin film layer 6 in the anti-reflection stacked member. In particular, if the thickness is outside this range, there is the problem of a decline in the anti-reflection performance. In general, if the thickness is too great the mechanical strength is high but flexibility becomes inadequate, whereas if the thickness is too small the flexibility is superior but mechanical strength tends to be inadequate.

In the present invention, the silicon oxide thin film of the outermost low-refractivity oxide thin film layer 6 is within the above-described thickness range, and moreover, in order to obtain both mechanical strength and flexibility, this film effectively includes two layers, which are an A layer 6a (on the transparent base film side) and a B layer 6b (on the outside). Furthermore, the composition ratios of silicon to oxygen (Si/O) in the A layer 6a and the B layer 6b must be such that the composition ratio of A layer 6a is higher than the composition ratio of B layer 6b. As a result of numerous researches on the characteristics of silicon oxide thin films, it was found by the inventor that mechanical strength becomes better when the Si/O composition ratio is low, whereas flexibility becomes better when the Si/O composition ratio is high. Applying this result, by adopting a state in which the A layer 6a having a superior flexibility, and the B layer 6b which is the outer layer, having a superior mechanical strength, are stacked, both mechanical strength and flexibility could be obtained for the anti-reflection film as a whole. In engineering terms, it is also possible to vary the composition ratio gradually, or change the composition ratio in steps, in the thickness direction. In macroscopic terms, such configurations can be understood using a model of a two-layer configuration, and being analogous to the present invention.

It is preferable that the composition ratio Si/O (A) of silicon to oxygen in the A layer 6a and the composition ratio Si/O (B) of silicon to oxygen in the B layer 6b be within the range 0.60≧Si/O (A)>Si/O (B). Specifically, if Si/O (A) is greater than 0.60, optical absorption increases, and, in general, there is limited practical application as anti-reflection film.

Furthermore, it is preferable that the thickness t (A) of the A layer 6a and the thickness t (B) of the B layer 6b be within the range of 4.5≧t (A)/t (B)≧0.8. Specifically, if the ratio is greater than 4.5 the mechanical strength does not reach the most desirable characteristics, and if it is less than 0.8 the flexibility does not reach the most desirable characteristics.

In order to vary the composition ratio when depositing the A layer 6a and B layer 6b, for example, when using a silicon target in reactive sputtering or the like, the amount of oxygen introduced as the reactive gas can be controlled to attain the different composition ratios. In addition, the amount of argon gas introduced as the sputtering gas, the discharge power, and other factors can be controlled to obtain similar effects.

In order to determine the composition ratios of the A layer 6a and B layer 6b, various types of analysis equipment may be used; of these, X-ray photoelectron spectroscopy (XPS) is one of the most widely employed analysis methods, and is suited for application in the present invention. Specifically, in the present invention, an ESCA3200 system, manufactured by Shimazu, was employed to determine composition ratios. Specifically, calculations were performed using the ratios of peak intensities for each element. When performing analyses in the depth direction, an ion beam was used to perform etching during analysis.

In the present invention, an antifouling layer 8 may be provided on the uppermost surface of the anti-reflection stacked member 9. An antifouling layer is a layer including a silicon compound containing fluorine having one or more silicon atoms bonded to a reactive functional group, or a layer including an organic silicon compound having the main chain based on siloxane bonds, or a layer including both of the above. In the present invention, a reactive functional group is a functional group which reacts with and bonds with the silicon oxide thin film which is the outermost low-refractivity oxide thin film layer.

An antifouling layer can be formed by evaporation deposition, sputtering, CVD, plasma polymerization, and other vacuum dry processes, as well as by micro gravure methods, screen coating methods, dip coating methods, and other wet processes. The film thickness of the antifouling layer is approximately 1 to 30 nm, and preferably is approximately 3 to 15 nm.

From the standpoint of waterproofing and antifouling, it is preferable that the contact angle of pure water at the surface of the antifouling layer be 90° or greater.

### EMBODIMENTS

Below, embodiments of the invention are explained more specifically; however, the present invention is not limited only to these embodiments.

### Conditions Common to Embodiments and Comparison Examples

As the transparent base film 1, triacetyl cellulose film of thickness 80 μm was used; on this film, an ultraviolet ray-curing acrylic resin was applied, and was dried and cured with ultraviolet rays to provide a hard coating layer 2 with the thickness of 5 μm. Thereafter, as a surface treatment of the hard coating layer 2, glow discharge treatment was performed. Then a silicon layer with a thickness of approximately 5 nm was deposited using a sputtering method as a primer layer. Then reactive sputtering was employed, using silicon oxide for low-refractivity oxide thin film layers and using niobium oxide for high-refractivity oxide thin film layers, to stack layers and form an anti-reflection stacked member. As the layer configuration of the anti-reflection stacked member, from the side closer to the hard coating layer 2, a niobium oxide layer, a silicon oxide layer, a niobium oxide layer, and a silicon oxide layer were formed in this order. The thicknesses of the layers were, in the order, 15 nm, 25 nm, 105 nm, with the thickness of the silicon oxide thin film of the outermost low-refractivity oxide thin film layer 6 varied in the embodiments and comparison examples.

### Embodiment 1

The thickness of the outermost silicon oxide thin film layer was made 85 nm, the thickness of the A layer 6a was 57 nm, and the thickness of the B layer 6b was 28 nm. As a result, the thickness ratio t (A)/t (B) was 2.04. The amounts of oxygen and argon introduced during film deposition were adjusted such that the composition ratio Si/O (A) of the A layer 6a was 0.556, and the composition ratio Si/O (B) of the B layer 6b was 0.518.

### Embodiment 2

The thickness of the outermost silicon oxide thin film layer was made 85 nm, the thickness of the A layer 6a was 57 nm, and the thickness of the B layer 6b was 28 nm. As a result, the thickness ratio t (A)/t (B) was 2.04. The amounts of oxygen and argon introduced during film deposition were adjusted such that the composition ratio Si/O (A) of the A layer 6a was 0.625, and the composition ratio Si/O (B) of the B layer 6b was 0.515.

### Embodiment 3

The thickness of the outermost silicon oxide thin film layer was made 85 nm, the thickness of the A layer 6a was 72 nm, and the thickness of the B layer 6b was 13 nm. As a result, the thickness ratio t (A)/t (B) was 5.54. The amounts of oxygen and argon introduced during film deposition were adjusted such that the composition ratio Si/O (A) of the A layer 6a was 0.552, and the composition ratio Si/O (B) of the B layer 6b was 0.521.

### Embodiment 4

The thickness of the outermost silicon oxide thin film layer was made 85 nm, the thickness of the A layer 6a was 35 nm, and the thickness of the B layer 6b was 50 nm. As a result, the thickness ratio t (A)/t (B) was 0.7. The amounts of oxygen and argon introduced during film deposition were adjusted such that the composition ratio Si/O (A) of the A layer 6a was 0.559, and the composition ratio Si/O (B) of the B layer 6b was 0.518.

### Comparison Example 1

The thickness of the outermost silicon oxide thin film layer was made 85 nm, the thickness of the A layer 6a was 85 nm, and the thickness of the B layer 6b was 0 nm. The amounts of oxygen and argon introduced during film deposition were adjusted such that the composition ratio Si/O (A) of the A layer 6a was 0.549.

### Comparison Example 2

The thickness of the outermost silicon oxide thin film layer was made 85 nm, the thickness of the A layer 6a was 0 nm, and the thickness of the B layer 6b was 85 nm. The amounts of oxygen and argon introduced during film deposition were adjusted such that the composition ratio Si/O (B) of the B layer 6b was 0.515.

### Comparison Example 3

The thickness of the outermost silicon oxide thin film layer was made 70 nm, the thickness of the A layer 6a was 47 nm, and the thickness of the B layer 6b was 23 nm. As a result, the thickness ratio t (A)/t (B) was 2.04. The amounts of oxygen and argon introduced during film deposition were adjusted such that the composition ratio Si/O (A) of the A layer 6a was 0.552, and the composition ratio Si/O (B) of the B layer 6b was 0.521.

### Comparison Example 4

The thickness of the outermost silicon oxide thin film layer was made 110 nm, the thickness of the A layer 6a was 73 nm, and the thickness of the B layer 6b was 37 nm. As a result, the thickness ratio t (A)/t (B) was 1.97. The amounts of oxygen and argon introduced during film deposition were adjusted such that the composition ratio Si/O (A) of the A layer 6a was 0.556, and the composition ratio Si/O (B) of the B layer 6b was 0.515.

### Comparison Example 5

The thickness of the outermost silicon oxide thin film layer was made 85 nm, the thickness of the A layer 6a was 57 mm, and the thickness of the B layer 6b was 28 nm. As a result, the thickness ratio t (A)/t (B) was 2.04. The amounts of oxygen and argon introduced during film deposition were adjusted such that the composition ratio Si/O (A) of the A layer 6a was 0.518, and the composition ratio Si/O (B) of the B layer 6b was 0.556.

### (Evaluation)

Samples obtained in the above embodiments and comparison examples were evaluated by the methods described below. Results are shown in Table 1.

### (1. Reflectivity and Transmissivity)

Measurements were performed using a model U4000 spectrophotometer manufactured by Hitachi Ltd. A unit with the specular reflection of 5° was employed for both measurements of reflectivity and transmissivity. When measuring reflectivity, the rear surface of the sample was sprayed with a delustering black application to cancel rear-surface reflection.

### (2. Mechanical Strength)

To evaluate mechanical strength, #0000 steel wool was fixed on an abrasion tester, a load of 300 gf was applied, each sample was passed through ten round-trip cycles of the abrasion tester, the state of abrasion (number of scratches) of the sample was observed visually, and comparative evaluations were performed. The judgment criteria were as follows.

A: No scratches

B: Fewer than 10 scratches

C: 10 or more scratches

### (3. Flexibility)

In order to evaluate flexibility, the state of cracks in the face of the anti-reflection stacked member occurring when the film was bent was observed visually, and comparisons made. The judgment criteria were as follows.

A: Less than 8 mm diameter

B: Less than 12 mm diameter

C: 12 mm diameter or greater

TABLE 1

| | Film thickness (nm) | | | | Composition ratio | | Reflectivity | Transmissivity | Mechanical | |
|---|---|---|---|---|---|---|---|---|---|---|
| | tA + tB | tA | tB | tA/tB | Si/O | Si/O | (%) | (%) | strength | Flexibility |
| Embodiment 1 | 85 | 57 | 28 | 2.04 | 0.556 | 0.518 | 0.20 | 95 | A | A |
| Embodiment 2 | 85 | 57 | 28 | 2.04 | 0.625 | 0.515 | 0.21 | 90 | A | A |
| Embodiment 3 | 85 | 72 | 13 | 5.54 | 0.552 | 0.521 | 0.21 | 95 | B | A |
| Embodiment 4 | 85 | 35 | 50 | 0.70 | 0.559 | 0.518 | 0.20 | 95 | A | B |
| Comparison | 85 | 85 | 0 | — | 0.549 | — | 0.21 | 95 | C | A |
| example 1 | | | | | | | | | | |
| Comparison | 85 | 0 | 85 | — | — | 0.515 | 0.20 | 95 | A | C |
| example 2 | | | | | | | | | | |
| Comparison | 70 | 47 | 23 | 2.04 | 0.552 | 0.521 | 0.70 | 95 | B | A |
| example 3 | | | | | | | | | | |
| Comparison | 110 | 73 | 37 | 1.97 | 0.556 | 0.515 | 0.80 | 95 | A | B |
| example 4 | | | | | | | | | | |
| Comparison | 85 | 57 | 28 | 2.04 | 0.518 | 0.556 | 0.20 | 95 | C | B |
| example 5 | | | | | | | | | | |

As a result of the experiments using the above embodiments and comparison examples, it is made clear that compared with the comparison examples, the embodiments of the present invention achieve both mechanical strength and flexibility, without in any way detracting from the optical characteristics required of anti-reflection films.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An anti-reflection film, comprising:
a transparent base film, on at least one face of which is provided a hard coating; and
an anti-reflection stacked member provided on the hard coating, having, in alternation, a high-refractivity oxide thin film layer and a low-refractivity oxide thin film layer, wherein:
an outermost layer of the anti-reflection stacked member is the low-refractivity oxide thin film layer;
the low-refractivity oxide thin film layer is a silicon oxide thin film;
a thickness of the silicon oxide thin film is in a range of 75 nm or greater, and 100 nm or smaller;
the silicon oxide thin film has a first layer on a side of the transparent base film, and a second layer on an outside of the first layer; and
a composition ratio Si/O (A) of silicon to oxygen in the first layer and a composition ratio Si/O (B) of silicon to oxygen in the second layer satisfies a relationship, Si/O (A)>Si/O (B).

2. The anti-reflection film according to claim 1, wherein the composition ratio Si/O (A) of silicon to oxygen in the first layer and the composition ratio Si/O (B) of silicon to oxygen in the second layer satisfies a relationship, 0.60≧Si/O (A)>Si/O (B).

3. The anti-reflection film according to claim 1, wherein a ratio t (A)/t (B) of a thickness t (A) of the first layer to a thickness t (B) of the second layer satisfies a relationship, 4.5≧t (A)/t (B)≧0.8.

4. The anti-reflection film according to claim 1, wherein the high-refractivity oxide thin film layer includes niobium oxide.

5. The anti-reflection film according to claim 1, wherein the transparent base film includes triacetyl cellulose.
